(19) United States
(12) Patent Application Publication
(10) Pub. No.: US 2026/0338938 A1
(43) Pub. Date: Oct. 29, 2026

(54) WIDE-RANGE DISPLACEMENT MONITORING METHOD

(71) Applicant: NATIONAL SUN YAT-SEN UNIVERSITY, Kaohsiung (TW)

(72) Inventors: Fu-Kang Wang, Kaohsiung (TW); Ji-Xun Zhong, Kaohsiung (TW); Ju-Yin Shih, Kaohsiung (TW)

(21) Appl. No.: 19/557,359

(22) Filed: Mar. 5, 2026

(30) Foreign Application Priority Data
Apr. 25, 2025 (TW) 114115736

(51) Int. Cl. G01S 13/58; G01S 7/35

(52) U.S. Cl. CPC G01S 13/583; G01S 7/354; G01S 7/358

(57) ABSTRACT

In a wide-range displacement monitoring method with waveform shaping and Doppler feature amelioration, four sequential quadrature channel signals obtained by a radar are processed through DC offset removal, linear combination, amplitude calibration, nonlinear combination and phase demodulation. Accurate phase demodulation can be achieved to enlarge the range for various displacement monitoring and overcome limitation of trajectory fitting method on displacement scale.

### CROSS-REFERENCE TO RELATED APPLICATIONS

This application claims priority to R.O.C patent application No. 114115736 filed Apr. 25, 2025, the disclosure of which is hereby incorporated by reference in its entirety.

### FIELD OF THE INVENTION

This invention relates to a displacement monitoring method, and more particularly to a wide-range displacement monitoring method with waveform shaping and Doppler feature amelioration.

### BACKGROUND OF THE INVENTION

Conventional Doppler radar sensor can sense target motion according to the Doppler effect on wireless signals, and sensing signals of the Doppler radar sensor involve carrier waves and Doppler signals. Extracting the Doppler signals from the sensing signals using a filter is difficult, hence, the sensing signals are usually divided into two channels (I channel and Q channel) and demodulated for Doppler signal extraction in prior arts. However, traditional IQ demodulation may encounter SNR issue at small displacement and spiral shape issue at large displacement that makes it hard to recover target displacement with a limitation of displacement range.

### SUMMARY OF THE INVENTION

One object of the present invention is to apply DC offset removal, linear combination, amplitude calibration and nonlinear combination on four channel signals for waveform shaping and Doppler feature amelioration. Complete Doppler phase information can be obtained through the present invention for wide-range displacement monitoring without shape and length limitations of IQ trajectory.

A wide-range displacement monitoring method includes the steps of four channel signals receiving, DC offset removal, linear combination, amplitude calibration, nonlinear combination and phase demodulation. A computing device receives four channel signals from a radar, phase difference between the first and second channel signals is 90 degrees, phase difference between the second and third channel signals is 90 degrees, and phase difference between the third and fourth channel signals is 90 degrees. DC offsets of the four channel signals are removed by the computing device to get four voltage signals, four voltage signals are linear-combined by the computing device to get four combined signals, the four combined signals are calibrated in amplitude by the computing device to get four amplitude-calibrated signals, the four amplitude-calibrated signals are nonlinear-combined by the computing device to get an in-phase channel signal and a quadrature channel signal, and the in-phase channel signal and the quadrature channel signal are demodulated by the computing device to obtain a Doppler phase.

The computing device of the present invention is provided to conduct DC offset removal, linear combination, amplitude calibration and nonlinear combination on the four channel signals obtained from the radar for waveform shaping and Doppler feature amelioration. Accurate Doppler phase can be obtained after phase demodulation for wide-range displacement monitoring without limitation of target displacement scale.

### BRIEF DESCRIPTION OF DRAWINGS

FIG. 1 is a flow chart illustrating a wide-range displacement monitoring method in accordance with one embodiment of the present invention.

FIG. 2 is a block diagram illustrating a radar and a computing device in accordance with one embodiment of the present invention.

FIG. 3 is a circuit diagram illustrating the radar in accordance with one embodiment of the present invention.

FIG. 4a shows waveforms of four channel signals at large displacement monitoring in accordance with one embodiment of the present invention.

FIG. 4b shows waveforms of four channel signals at small displacement monitoring in accordance with one embodiment of the present invention.

FIG. 5a shows waveforms of four voltage signals at large displacement monitoring in accordance with one embodiment of the present invention.

FIG. 5b shows waveforms of four voltage signals at small displacement monitoring in accordance with one embodiment of the present invention.

FIG. 6a shows waveforms of four combined signals at large displacement monitoring in accordance with one embodiment of the present invention.

FIG. 6b shows waveforms of four combined signals at small displacement monitoring in accordance with one embodiment of the present invention.

FIG. 7a shows waveforms of four amplitude-calibrated signals at large displacement monitoring in accordance with one embodiment of the present invention.

FIG. 7b shows waveforms of four amplitude-calibrated signals at small displacement monitoring in accordance with one embodiment of the present invention.

FIG. 8a shows waveforms of an in-phase channel signal and a quadrature channel signal at large displacement monitoring in accordance with one embodiment of the present invention.

FIG. 8b shows waveforms of an in-phase channel signal and a quadrature channel signal at small displacement monitoring in accordance with one embodiment of the present invention.

FIG. 9a shows waveforms of an optimized in-phase channel signal and an optimized quadrature channel signal at large displacement monitoring in accordance with one embodiment of the present invention.

FIG. 9b shows waveforms of an optimized in-phase channel signal and an optimized quadrature channel signal at small displacement monitoring in accordance with one embodiment of the present invention.

FIG. 10a is an IQ trajectory plot before and after optimization at large displacement monitoring in accordance with one embodiment of the present invention.

FIG. 10b is an IQ trajectory plot before and after optimization at small displacement monitoring in accordance with one embodiment of the present invention.

FIG. 11a is a comparison diagram of phase recovery result in accordance with one embodiment of the present invention and corresponding reference waveforms at large displacement monitoring.

FIG. 11b is a comparison diagram of phase recovery result in accordance with one embodiment of the present invention and corresponding reference waveforms at small displacement monitoring.

### DETAILED DESCRIPTION OF THE INVENTION

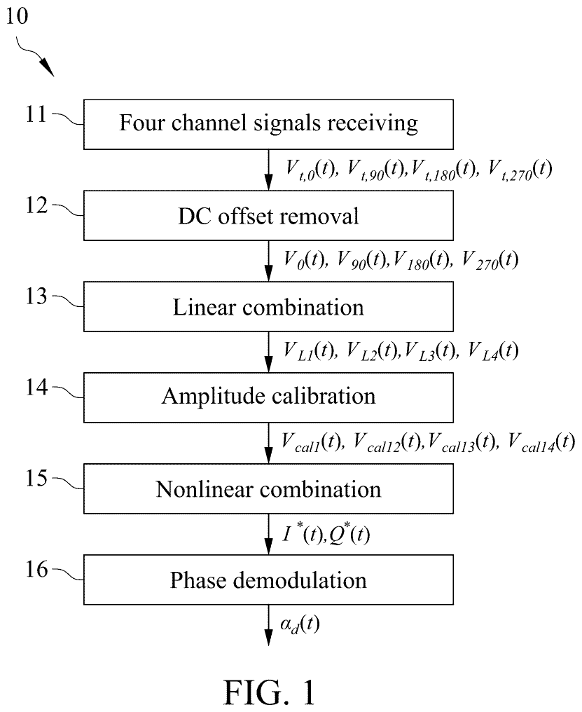

With reference to FIG. 1, a wide-range displacement monitoring method 10 in accordance with one embodiment of the present invention includes a step 11 of four channel signals receiving, a step 12 of DC offset removal, a step 13 of linear combination, a step 14 of amplitude calibration, a step 15 of nonlinear combination and a step 16 of phase demodulation.

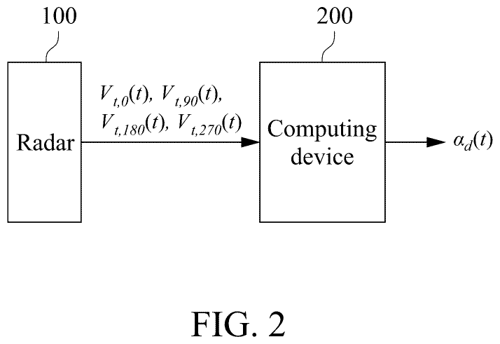

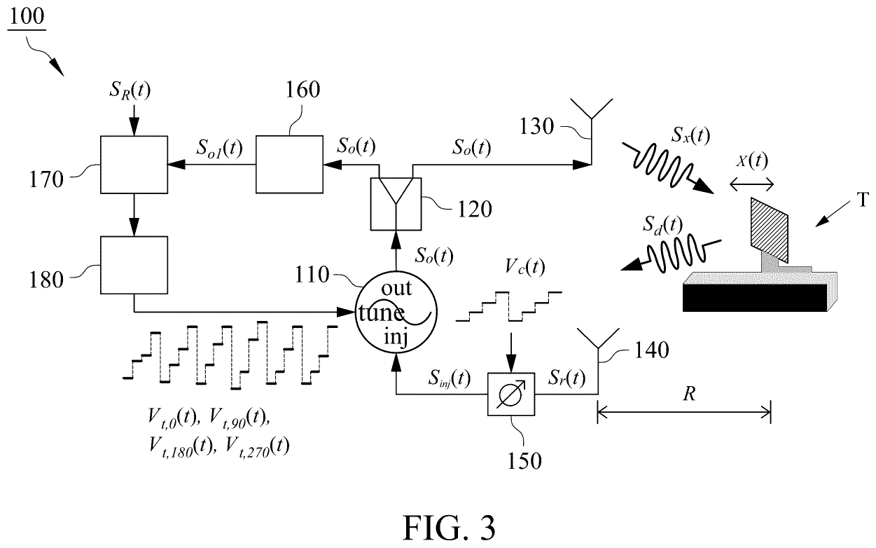

With reference to FIGS. 1 and 2, in the step 11 of four channel signals receiving, a computing device 200 receives a first channel signal V_{t,0}(t), a second channel signal V_{t,90}(t), a third channel signal V_{t,180}(t) and a fourth channel signal V_{t,270}(t) from a radar 100. The phase difference between the first and second channel signals V_{t,0}(t), V_{t,90}(t) is 90 degrees, the phase difference between the second and third channel signals V_{t,90}(t), V_{t,180}(t) is 90 degrees, and the phase difference between the third and fourth channel signals V_{t,180}(t), V_{t,270}(t) is 90 degrees. The radar 100 is, but not limited to, a four-channel phase- and quadrature self-injection-locked radar (PQSIL radar) as shown in FIG. 3, and the computing device 200 is a computer or mobile device with logic operation ability. The radar 100 may be other four-channel Doppler radars in other embodiments.

With reference to FIG. 3, in this embodiment, the radar 100 includes a self-injection-locked oscillator (SILO) 110, a splitter 120, a transmit antenna 130, a receive antenna 140, a phase shifter 150, a frequency divider 160, a phase frequency detector 170 and a loop filter 180. The SILO 110 has an output port out, an injection port inj and a tuning port tune and it output an oscillation signal Sₒ(t) from its output port out. The oscillation signal Sₒ(t) is received and divided into two paths by the splitter 120 which is electrically connected to the SILO 110, one path is transmitted to the transmit antenna 130 and the other path is transmitted to the frequency divider 160. The oscillation signal Sₒ(t) received by the transmit antenna 130 is transmitted to a moving target T as a transmit signal Sₓ(t), a detection signal S_{d}(t) is reflected from the moving target T and received by the receive antenna 140 as a received signal Sᵣ(t). The received signal Sᵣ(t) is transmitted to the phase shifter 150 which is electrically connected to the receive antenna 140, a controlled signal V_{c}(t) received by the phase shifter 150 provides a phase delay with an angle of 0 degree, 90 degrees, 180 degrees and 270 degrees in the received signal Sᵣ(t) to obtain an injection signal Sᵢₙⱼ(t) with four different phase modes. The injection signal Sᵢₙⱼ(t) is injected into the SILO 110 via the injection port inj to lock the SILO 110.

Displacement of the moving target T relative to the radar 100 causes the Doppler effect on the transmit signal Sₓ(t) such that the detection signal S_{d}(t), the received signal Sᵣ(t) and the injection signal Sᵢₙⱼ(t) have Doppler phase shifts associated with motion of the moving target T. As the SILO 110 is locked by the injection signal Sᵢₙⱼ(t), the Doppler phase shift in the injection signal Sᵢₙⱼ(t) varies the oscillation frequency of the SILO 110. Owing to the injection signal Sᵢₙⱼ(t) has four phase modes, the SILO 110 locked by the injection signal Sᵢₙⱼ(t) operates at four phase modes.

The oscillation signal Sₒ(t) of the other path is received and divided by the frequency divider 160 to become a frequency-divided oscillation signal Sₒ₁(t). The frequency-divided oscillation signal Sₒ₁(t) is transmitted to the phase frequency detector 170, compared to a reference signal S_{R}(t) in frequency and phase and then transmitted to the tuning port tune of the SILO 110 as the four channel signals V_{t,0}(t), V_{t,90}(t), V_{t,180}(t), V_{t,270}(t) via the loop filter 180. The frequency divider 160, the phase frequency detector 170 and the loop filter 180 form a locked loop circuit capable of stabilizing oscillation frequency of the SILO 110. Hence, the four channel signals V_{t,0}(t), V_{t,90}(t), V_{t,180}(t), V_{t,270}(t) contain the Doppler phase shift corresponding to the displacement of the moving target T.

In this embodiment, the first channel signal V_{t,0}(t), the second channel signal V_{t,90}(t), the third channel signal V_{t,180}(t) and the fourth channel signal V_{t,270}(t) are derived as

$$\{ \begin{matrix}{V}_{t , 0} ( t ) = {V}_{i} + \frac{{ω}_{LR} ( t )}{{K}_{v}} \times sin {α}_{d} ( t ) \\ {V}_{t , 90} ( t ) = {V}_{i} - \frac{{ω}_{LR} ( t )}{{K}_{v}} \times cos {α}_{d} ( t ) \\ {V}_{t , 180} ( t ) = {V}_{i} - \frac{{ω}_{LR} ( t )}{{K}_{v}} \times sin {α}_{d} ( t ) \\ {V}_{t , 270} ( t ) = {V}_{i} + \frac{{ω}_{LR} ( t )}{{K}_{v}} \times cos {α}_{d} ( t )\end{matrix} ,$$

where Vᵢ is an initial tuning voltage of the SILO 110 in the radar 100, ω_{LR}(t) is a locking range of the SILO 110, K_{V} is a tuning sensitivity of the SILO 110, and α_{d}(t) is the Doppler phase and it is given as

$${α}_{d} ( t ) = \frac{2 {ω}_{osc}}{c} ( R + X ( t ) ) ,$$

where ω_{OSC} is an inherent oscillation frequency of the SILO 110, c is the speed of light, R is an initial distance between the moving target T and the radar 100, and X(t) is the displacement of the moving target T.

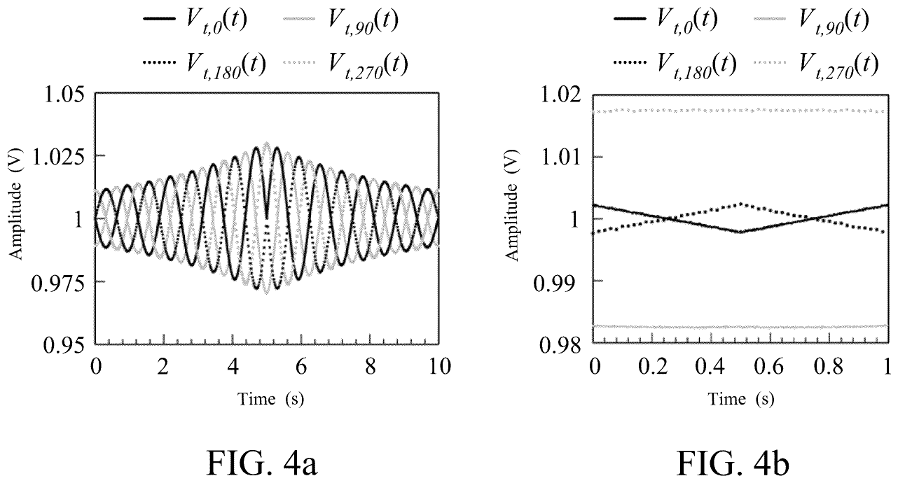

FIGS. 4a and 4b show waveforms of the four channel signals V_{t,0}(t), V_{t,90}(t), V_{t,180}(t), V_{t,270}(t) at large displacement (2)) and small displacement (λ/50) of the moving target T, respectively. The four channel signals V_{t,0}(t), V_{t,90}(t), V_{t,180}(t), V_{t,270}(t) all have DC offset as shown in FIGS. 4a and 4b. The first and third channel signals V_{t,0}(t), V_{t,180}(t) with opposite phases present the same DC term and opposite AC term, and the second and fourth channel signals V_{t,90}(t), V_{t,270}(t) with opposite phases present the same DC term and opposite AC term. Accordingly, the DC term can be calculated and removed using the two pair channel signals.

With reference to FIGS. 1 and 2, in the step 12 of DC offset removal, the computing device 200 removes DC terms in the four channel signals V_{t,0}(t), V_{t,90}(t), V_{t,180}(t), V_{t,270}(t) to obtain a first voltage signal V₀(t), a second voltage signal V₉₀(t), a third voltage signal V₁₈₀(t) and a fourth voltage signal V₂₇₀(t). The DC offset removal can be given as

$$\{ \begin{matrix}{V}_{0} ( t ) = {V}_{t , 0} ( t ) - \frac{( {V}_{t , 0} ( t ) + {V}_{t , 180} ( t ) )}{2} = K ( t ) sin {α}_{d} ( t ) \\ {V}_{180} ( t ) = {V}_{t , 180} ( t ) - \frac{( {V}_{t , 0} ( t ) + {V}_{t , 180} ( t ) )}{2} = - K ( t ) sin {α}_{d} ( t )\end{matrix}$$

$$and$$

$$\{ \begin{matrix}{V}_{90} ( t ) = {V}_{t , 90} ( t ) - \frac{( {V}_{t , 90} ( t ) + {V}_{t , 270} ( t ) )}{2} = - K ( t ) cos {α}_{d} ( t ) \\ {V}_{270} ( t ) = {V}_{t , 270} ( t ) - \frac{( {V}_{t , 90} ( t ) + {V}_{t , 270} ( t ) )}{2} = K ( t ) cos {α}_{d} ( t )\end{matrix} ,$$

where K (t) is represented as

$$K ( t ) = \frac{{ω}_{LR} ( t )}{{K}_{v}} .$$

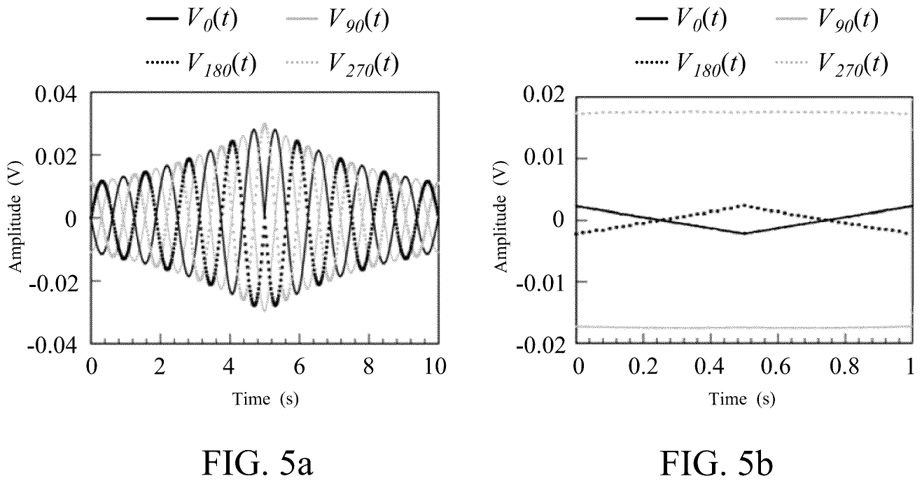

FIGS. 5a and 5b show waveforms of the four voltage signals V₀(t), V₉₀(t), V₁₈₀(t), V₂₇₀(t) at large and small displacements of the moving target T, respectively. The DC terms in the four voltage signals V₀(t), V₉₀(t), V₁₈₀(t), V₂₇₀(t) are all calibrated as shown in FIGS. 5a and 5b. With reference to FIG. 5b, during small displacement monitoring, the waveforms of the first and third voltage signals V₀(t), V₁₈₀(t) are varied with displacement trajectory of the moving target T, but the waveforms of the second and fourth voltage signals V₉₀(t), V₂₇₀(t) encounter null point and nonlinear distortion issues.

With reference to FIGS. 1 and 2, in order to address nonlinear distortion, the first, second third and fourth voltage signals V₀(t), V₉₀(t), V₁₈₀(t), V₂₇₀(t) are linear combined by the computing device 200 to generate a first combined signal V_{L1}(t), a second combined signal V_{L2}(t), a third combined signal V_{L3}(t) and a fourth combined signal V_{L4}(t) in the step 13 of linear combination. The linear combination, which is named a waveform shaping process, can be expressed as follows

$$[ \begin{matrix}{V}_{L 1} ( t ) \\ {V}_{L 2} ( t ) \\ {V}_{L 3} ( t ) \\ {V}_{L 4} ( t )\end{matrix} ] = {V}_{0} ( t ) [ \begin{matrix}1 \\ 1 \\ 1 \\ - 1\end{matrix} ] + {V}_{90} ( t ) [ \begin{matrix}3 \\ 3 \\ - 3 \\ 3\end{matrix} ] + {V}_{180} ( t ) [ \begin{matrix}- 3 \\ - 3 \\ - 3 \\ 3\end{matrix} ] + {V}_{270} ( t ) [ \begin{matrix}- 1 \\ 1 \\ 1 \\ 1\end{matrix} ] ,$$

and the four combined signals V_{L1}(t), V_{L2}(t), V_{L3}(t), V_{L4}(t) can be simplified as

$$\{ \begin{matrix}{V}_{L 1} ( t ) = 2 \sqrt{10} K ( t ) cos {φ}_{2} \times sin ( {α}_{d} ( t ) + {φ}_{1} ) \\ {V}_{L 2} ( t ) = 2 \sqrt{10} K ( t ) cos {φ}_{1} \times sin ( {α}_{d} ( t ) + {φ}_{2} ) \\ {V}_{L 3} ( t ) = 2 \sqrt{10} K ( t ) cos {φ}_{2} \times sin ( {α}_{d} ( t ) - {φ}_{1} ) \\ {V}_{L 4} ( t ) = 2 \sqrt{10} K ( t ) cos {φ}_{1} \times sin ( {α}_{d} ( t ) - {φ}_{2} )\end{matrix} ,$$

where φ₁ is a first initial phase and φ₂ is a second initial phase. In this embodiment, the first initial phase is represented as

φ₁=(θ₁+θ₂)/2,

and the second initial phase is represented as

φ₂=(θ₁+θ₂)/2,

where ϑ₁=tan⁻¹(−3) and ϑ₂=tan⁻¹(−⅓).

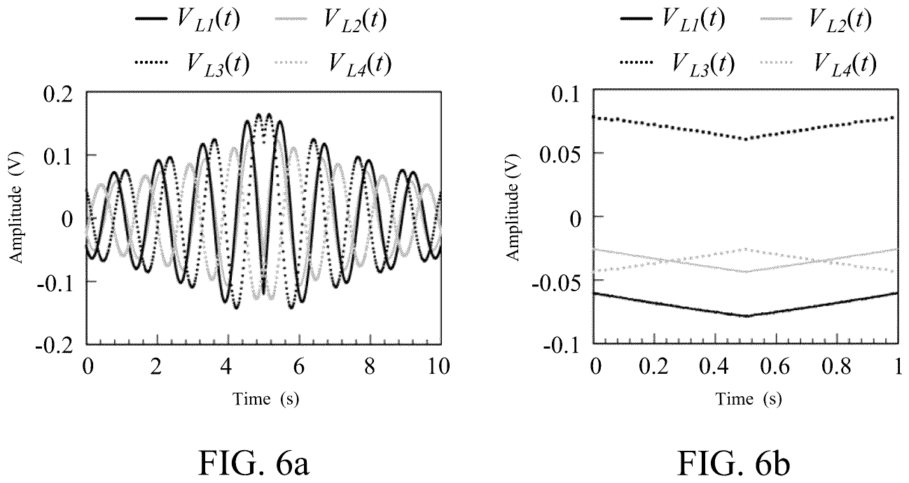

FIGS. 6a and 6b show waveforms of the four combined signals V_{L1}(t), V_{L2}(t), V_{L3}(t), V_{L4}(t) at large and small displacements of the moving target T, respectively. As shown in FIGS. 6a and 6b, the four combined signals V_{L1}(t), V_{L2}(t), V_{L3}(t), V_{L4}(t) obtained after linear combination all reveal the Doppler feature resulted from the displacement of the moving target T, and nonlinear distortion caused by null point problem during small displacement monitoring is mitigated significantly.

As shown in FIGS. 6a and 6b, amplitude levels of the four combined signals V_{L1}(t), V_{L2}(t), V_{L3}(t), V_{L4}(t) are different at large and small displacements, the first and third combined signals V_{L1}(t), V_{L3}(t) exhibit the same amplitude, and the second and fourth combined signals V_{L2}(t), V_{L4}(t) exhibit the same amplitude.

With reference to FIGS. 1 and 2, in the step 14 of amplitude calibration, the computing device 200 calibrates amplitudes of the four combined signals V_{L1}(t), V_{L2}(t), V_{L3}(t), V_{L4}(t) to obtain a first amplitude-calibrated signal V_{cal1}(t), a second amplitude-calibrated signal V_{cal2}(t), a third amplitude-calibrated signal V_{cal3}(t) and a fourth amplitude-calibrated signal V_{cal4}(t). In this embodiment, amplitude calibration of the four combined signals V_{L1}(t), V_{L2}(t), V_{L3}(t), V_{L4}(t) includes two sub-steps. In the first sub-step, the computing device 200 evaluates a first amplitude calibration factor utilizing the first and third combined signals V_{L1}(t), V_{L3}(t) and evaluates a second amplitude calibration factor utilizing the second and fourth combined signals V_{L2}(t), V_{L4}(t). In the second sub-step, the computing device 200 divides the first and third combined signals V_{L1}(t), V_{L3}(t) by the first amplitude calibration factor to produce the first and third amplitude-calibrated signals V_{cal1}(t), V_{cal3}(t), and divides the second and fourth combined signals V_{L2}(t), V_{L4}(t) by the second amplitude calibration factor to produce the second and fourth amplitude-calibrated signals V_{cal2}(t), V_{cal4}(t).

Amplitude calibration of the four combined signals V_{L1}(t), V_{L2}(t), V_{L3}(t), V_{L4}(t) can be derived as

$$\{ \begin{matrix}A = \sqrt{\vert \frac{1}{T} {\sum }_{t = 1}^{T} ( {V}_{L 1}^{2} ( t ) + {V}_{L 3}^{2} ( t ) ) \vert} = \vert 2 \sqrt{10} K ( t ) cos {φ}_{2} \vert \times \sqrt{\vert 1 - cos 2 {φ}_{1} \times M \vert} \\ B = \sqrt{\vert \frac{1}{T} {\sum }_{t = 1}^{T} ( {V}_{L 2}^{2} ( t ) + {V}_{L 4}^{2} ( t ) ) \vert} = \vert 2 \sqrt{10} K ( t ) cos {φ}_{1} \vert \times \sqrt{\vert 1 - cos 2 {φ}_{2} \times M \vert}\end{matrix} ,$$

where A is the first amplitude calibration factor, B is the second amplitude calibration factor, M is a Doppler phase factor and it is given as

$$M = \frac{1}{T} {\sum }_{t = 1}^{T} cos 2 {α}_{d} ( t ) .$$

The computing device 200 divides the first and third combined signals V_{L1}(t), V_{L3}(t) by the first amplitude calibration factor to obtain the first and third amplitude-calibrated signals V_{cal1}(t), V_{cal3}(t), and divides the second and fourth combined signals V_{L2}(t), V_{L4}(t) by the second amplitude calibration factor to obtain the second and fourth amplitude-calibrated signals V_{cal2}(t), V_{cal4}(t). The four amplitude-calibrated signals V_{cal1}(t), V_{cal2}(t), V_{cal3}(t), V_{cal4}(t) can be derived as

$$\{ \begin{matrix}{V}_{cal 1} ( t ) = \frac{{V}_{L 1} ( t )}{A} = \frac{sin ( {α}_{d} ( t ) - {φ}_{1} )}{\sqrt{\vert 1 - M cos 2 {φ}_{1} \vert}} \\ {V}_{cal 2} ( t ) = \frac{{V}_{L 2} ( t )}{A} = \frac{sin ( {α}_{d} ( t ) - {φ}_{2} )}{\sqrt{\vert 1 - M cos 2 {φ}_{2} \vert}} \\ {V}_{cal 3} ( t ) = \frac{{V}_{L 3} ( t )}{A} = \frac{sin ( {α}_{d} ( t ) - {φ}_{1} )}{\sqrt{\vert 1 - M cos 2 {φ}_{1} \vert}} \\ {V}_{cal 4} ( t ) = \frac{{V}_{L 4} ( t )}{A} = \frac{sin ( {α}_{d} ( t ) - {φ}_{2} )}{\sqrt{\vert 1 - M cos 2 {φ}_{2} \vert}}\end{matrix}$$

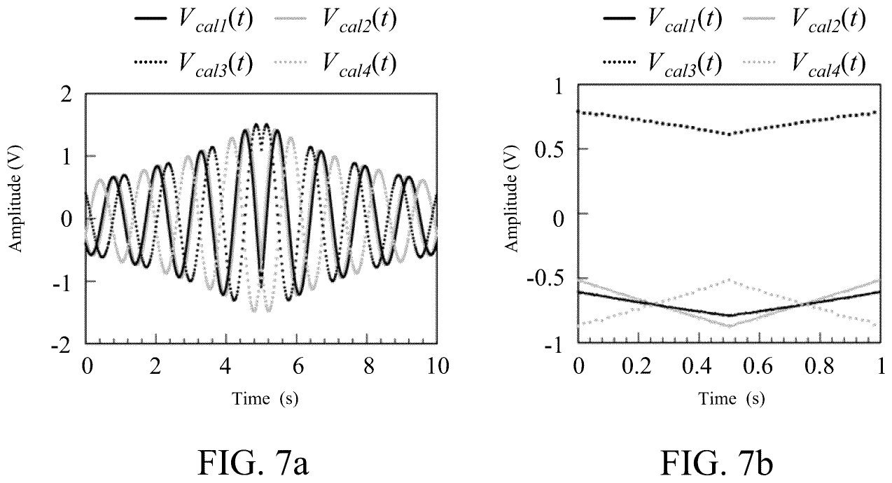

FIGS. 7a and 7b show waveforms of the four amplitude-calibrated signals V_{cal1}(t), V_{cal2}(t), V_{cal3}(t), V_{cal4}(t) at large and small displacements of the moving target T, respectively. The amplitude calibration results show that the four amplitude-calibrated signals V_{cal1}(t), V_{cal2}(t), V_{cal3}(t), V_{cal4} (t) have similar amplitude levels.

With reference to FIGS. 1 and 2, in the step 15 of nonlinear combination, the four amplitude-calibrated signals V_{cal1}(t), V_{cal2}(t), V_{cal3}(t), V_{cal4}(t) are nonlinear-combined by the computing device 200 to produce an in-phase channel signal I(t) and a quadrature channel signal Q(t) for further Doppler phase recovery with arctangent demodulation. In this embodiment, nonlinear combination of the four amplitude-calibrated signals V_{cal1}(t), V_{cal2}(t), V_{cal3}(t), V_{cal4}(t) can be expressed as

$$I ( t ) = {V}_{cal 1}^{2} ( t ) - {V}_{cal 2}^{2} ( t ) + {V}_{cal 3}^{2} ( t ) - {V}_{cal 4}^{2} ( t ) = \frac{1}{\vert 1 - M cos 2 {φ}_{1} \vert} - \frac{1}{\vert 1 - M cos 2 {φ}_{2} \vert} + ( - \frac{cos 2 {φ}_{1}}{\vert 1 - M cos 2 {φ}_{1} \vert} + \frac{cos 2 {φ}_{2}}{\vert 1 - M cos 2 {φ}_{1} \vert} ) cos 2 {α}_{d} ( t )$$

$$and$$

$$Q ( t ) = - {V}_{cal 1}^{2} ( t ) - {V}_{cal 2}^{2} ( t ) + {V}_{cal 3}^{2} ( t ) + {V}_{cal 4}^{2} ( t ) = - ( \frac{sin 2 {φ}_{1}}{\vert 1 - M cos 2 {φ}_{1} \vert} + \frac{sin 2 {φ}_{2}}{\vert 1 - M cos 2 {φ}_{2} \vert} ) sin 2 {α}_{d} ( t ) .$$

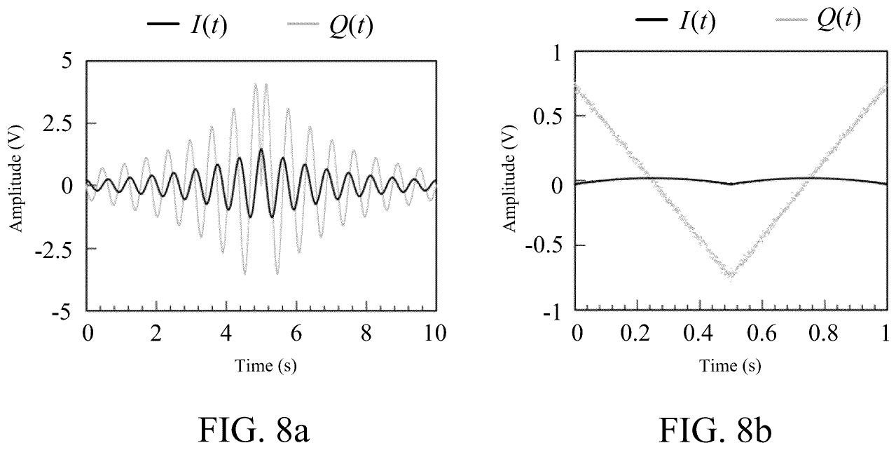

FIGS. 8a and 8b show waveforms of the in-phase channel signal I(t) and the quadrature channel signal Q(t) at large and small displacements of the moving target T, respectively. In this embodiment, the nonlinear combination is proceeded by utilizing a square operation applying on the four amplitude-calibrated signals V_{cal1}(t), V_{cal2}(t), V_{cal3}(t), V_{cal4}(t) to produce the in-phase channel signal I(t) and the quadrature channel signal Q(t) with two-time increase of the Doppler phase α_{d}(t) for ameliorating Doppler features significantly. Referring to FIG. 8b, after nonlinear combination, the in-phase channel signal I(t) and the quadrature channel signal Q(t) at small displacement of the moving target T are increased in amplitude, indicating Doppler feature amelioration is achieved.

As shown in FIGS. 8a and 8b, amplitude imbalance and DC offset are observed in the in-phase channel signal I(t) and the quadrature channel signal Q(t). With reference to FIG. 1, preferably, the computing device 200 optimizes the in-phase channel signal I(t) and the quadrature channel signal Q(t) via a one-unknown-parameter optimization (Pythagorean trigonometric identity, PTI) before the step 16 of phase demodulation to find the Doppler phase factor M, the one-unknown-parameter optimization can be represented as

I*²(t)+Q*²(t)=1,

where I*(t) is an optimized in-phase channel signal, and Q*(t) is an optimized quadrature channel signal. The only one unknown parameter in the in-phase channel signal I(t) and the quadrature channel signal Q(t) is the Doppler phase factor M, so the one-unknown-parameter optimization can be completed rapidly. Computation time for the optimization utilizing the one-unknown-parameter optimization in this embodiment can be reduced substantially compared to the conventional trajectory fitting process.

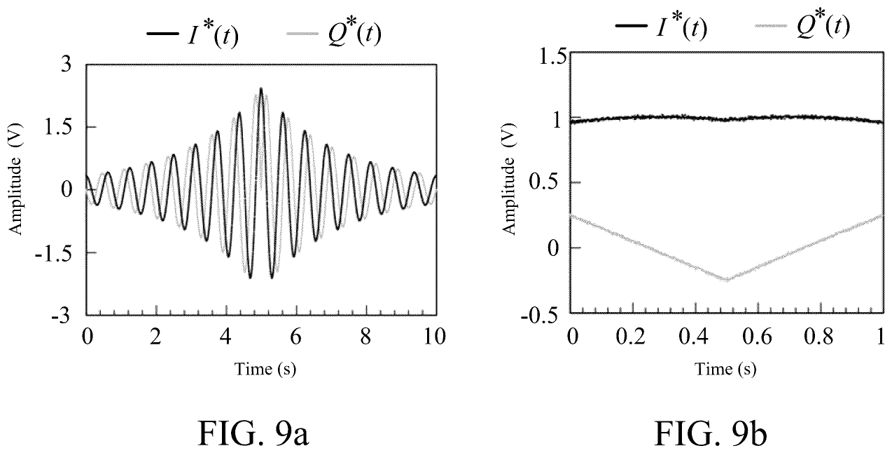

FIGS. 9a and 9b show waveforms of the optimized in-phase channel signal I*(t) and the optimized quadrature channel signal Q*(t) at large and small displacements of the moving target T, respectively. The results as shown in FIGS. 9a and 9b reveal that amplitude imbalance and DC offset are properly calibrated.

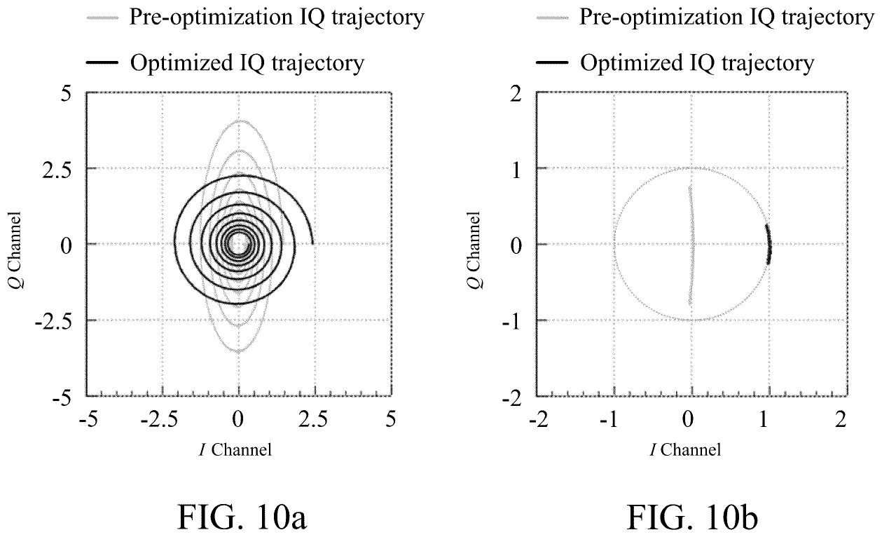

FIG. 10a is an IQ trajectory plot before and after the one-unknown-parameter optimization at large displacement of the moving target T, and FIG. 10b is an IQ trajectory plot before and after the one-unknown-parameter optimization at small displacement of the moving target T. IQ trajectory at large displacement before the one-unknown-parameter optimization has an elliptical spiral shape as shown in FIG. 10a, revealing amplitudes of IQ channels are varied with time to deteriorate center estimation result with the conventional trajectory fitting method that cannot find a correct circle trajectory to fit the elliptical spiral shape with dynamic radius. Relatively, IQ trajectory at large displacement after the one-unknown-parameter optimization of this embodiment has a circle spiral shape. Referring to FIG. 10b, IQ trajectory at the small displacement before the one-unknown-parameter optimization is vulnerable to signal-to-noise ratio (SNR) and has long vertical line shape near the origin point that cannot find a correct fit circle. On the contrary, IQ trajectory at small displacement after the one-unknown-parameter optimization of this embodiment can also correct an elliptical trajectory into a circular one.

With reference to FIGS. 1 and 2, in the step 16 of phase demodulation, the computing device 200 demodulates the in-phase channel signal I(t) and the quadrature channel signal Q(t) to obtain the Doppler phase α_{d}(t). In this embodiment, the computing device 200 applies an arctangent demodulation on the optimized in-phase channel signal I*(t) and the optimized quadrature channel signal Q*(t) to obtain the Doppler phase α_{d}(t). The arctangent demodulation can be derived as

$${α}_{d} ( t ) = \frac{1}{2} {tan}^{- 1} ( \frac{Q * ( t )}{I * ( t )} ) = \frac{1}{2} {tan}^{- 1} ( \frac{sin 2 {α}_{d} ( t )}{cos 2 {α}_{d}} ) .$$

Owing to the Doppler feature is increased twofold after the step 15 of nonlinear combination, the Doppler phase α_{d}(t) can be obtained after the arctangent demodulation by dividing the result by 2.

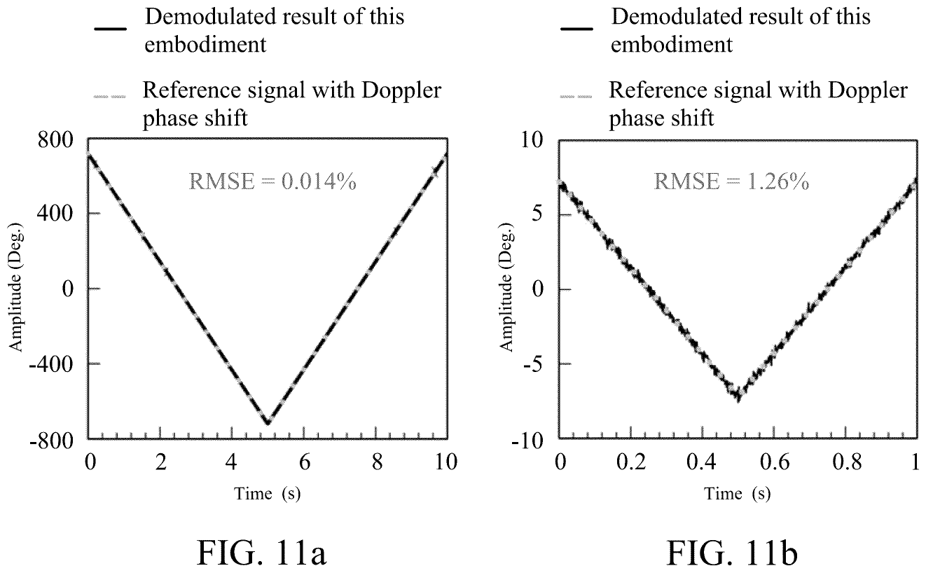

FIG. 11a is a comparison diagram of the demodulated result obtained by the monitoring method of this embodiment and corresponding reference waveforms at large displacement of the moving target T, and FIG. 11b is a comparison diagram of the demodulated result obtained by the monitoring method of this embodiment and corresponding reference waveforms at small displacement of the moving target T. Root-mean-square error (RMSE) of phase recovery results at large and small displacements are 0.014% and 1.26%, respectively. This indicates that the present invention can detect the Doppler phase α_{d}(t) precisely and recover target motion correctly. And in other embodiments, RMSE values for wide-range displacement monitoring from 0.001λ to 8λ (with 8000 times difference in the displacement range) are all less than 2.5%.

The computing device 200 applies DC offset removal, linear combination, amplitude calibration and nonlinear combination on the four channel signals for waveform shaping and Doppler feature amelioration, and applies phase demodulation on the signals to obtain the Doppler phase α_{d}(t) precisely. The wide-range displacement monitoring method of the present invention has no limitation on displacement scale of the moving target T.

The scope of the present invention is only limited by the following claims. Any alternation and modification without departing from the scope and spirit of the present invention will become apparent to those skilled in the art.

1. A wide-range displacement monitoring method comprising:
receiving a first channel signal, a second channel signal, a third channel signal and a fourth channel signal from a radar by a computing device, wherein a phase difference between the first and second channel signals is 90 degrees, a phase difference between the second and third channel signals is 90 degrees, and a phase difference between the third and fourth channel signals is 90 degrees;
removing DC offsets in the first, second, third and fourth channel signals by the computing device to obtain a first voltage signal, a second voltage signal, a third voltage signal and a fourth voltage signal;
linear-combining the first, second, third and fourth voltage signals by the computing device to obtain a first combined signal, a second combined signal, a third combined signal and a fourth combined signal;
calibrating amplitudes of the first, second, third and fourth combined signals by the computing device to obtain a first amplitude-calibrated signal, a second amplitude-calibrated signal, a third amplitude-calibrated signal and a fourth amplitude-calibrated signal;
nonlinear-combining the first, second, third and fourth amplitude-calibrated signals by the computing device to obtain an in-phase channel signal and a quadrature channel signal; and
demodulating the in-phase channel signal and the quadrature channel signal by the computing device to obtain a Doppler phase.

2. The wide-range displacement monitoring method in accordance with claim 1, wherein the first, second, third and fourth channel signals are derived as
$$\{ \begin{matrix}{V}_{t , 0} ( t ) = {V}_{i} + \frac{{ω}_{LR} ( t )}{{K}_{v}} \times sin {α}_{d} ( t ) \\ {V}_{t , 90} ( t ) = {V}_{i} - \frac{{ω}_{LR} ( t )}{{K}_{v}} \times cos {α}_{d} ( t ) \\ {V}_{t , 180} ( t ) = {V}_{i} - \frac{{ω}_{LR} ( t )}{{K}_{v}} \times sin {α}_{d} ( t ) \\ {V}_{t , 270} ( t ) = {V}_{i} + \frac{{ω}_{LR} ( t )}{{K}_{v}} \times cos {α}_{d} ( t )\end{matrix} ,$$
where V_{t,0}(t) is the first channel signal, V_{t,90}(t) is the second channel signal, V_{t,180}(t) is the third channel signal, V_{t,270}(t) is the fourth channel signal, Vᵢ is an initial tuning voltage of a self-injection-locked oscillator (SILO) in the radar, ω_{LR}(t) is a locking range of the SILO, K_{V} is a tuning sensitivity of the SILO, and α_{d}(t) is the Doppler phase.

3. The wide-range displacement monitoring method in accordance with claim 2, wherein removal of DC offsets in the first, second, third and fourth channel signals are given as
$$\{ \begin{matrix}{V}_{0} ( t ) = {V}_{t , 0} ( t ) - \frac{( {V}_{t , 0} ( t ) + {V}_{t , 180} ( t ) )}{2} = K ( t ) sin {α}_{d} ( t ) \\ {V}_{180} ( t ) = {V}_{t , 180} ( t ) - \frac{( {V}_{t , 0} ( t ) + {V}_{t , 180} ( t ) )}{2} = - K ( t ) sin {α}_{d} ( t )\end{matrix}$$
$$and$$
$$\{ \begin{matrix}{V}_{90} ( t ) = {V}_{t , 90} ( t ) - \frac{( {V}_{t , 90} ( t ) + {V}_{t , 270} ( t ) )}{2} = - K ( t ) sin {α}_{d} ( t ) \\ {V}_{270} ( t ) = {V}_{t , 270} ( t ) - \frac{( {V}_{t , 90} ( t ) + {V}_{t , 270} ( t ) )}{2} = K ( t ) sin {α}_{d} ( t )\end{matrix} ,$$
where V₀(t) is the first voltage signal, V₉₀(t) is the second voltage signal, V₁₈₀(t) is the third voltage signal, V₂₇₀(t) is the fourth voltage signal, and K(t) is represented as
$$K ( t ) = \frac{{ω}_{LR} ( t )}{{K}_{v}} .$$

4. The wide-range displacement monitoring method in accordance with claim 3, wherein linear combination of the first, second, third and fourth voltage signals is expressed as
$$[ \begin{matrix}{V}_{L 1} ( t ) \\ {V}_{L 2} ( t ) \\ {V}_{L 3} ( t ) \\ {V}_{L 4} ( t )\end{matrix} ] = {V}_{0} ( t ) [ \begin{matrix}1 \\ 1 \\ 1 \\ - 1\end{matrix} ] + {V}_{90} ( t ) [ \begin{matrix}3 \\ 3 \\ - 3 \\ 3\end{matrix} ] + {V}_{180} ( t ) [ \begin{matrix}- 3 \\ - 3 \\ - 3 \\ 3\end{matrix} ] + {V}_{270} ( t ) [ \begin{matrix}- 1 \\ 1 \\ 1 \\ 1\end{matrix} ] ,$$
where V_{L1}(t) is the first combined signal, V_{L2}(t) is the second combined signal, V_{L3}(t) is the third combined signal, V_{L4}(t) is the fourth combined signal, and the first, second, third and fourth combined signals are derived as
$$\{ \begin{matrix}{V}_{L 1} ( t ) = 2 \sqrt{10} K ( t ) cos {φ}_{2} \times sin ( {α}_{d} ( t ) + {φ}_{1} ) \\ {V}_{L 2} ( t ) = 2 \sqrt{10} K ( t ) cos {φ}_{1} \times sin ( {α}_{d} ( t ) + {φ}_{2} ) \\ {V}_{L 3} ( t ) = 2 \sqrt{10} K ( t ) cos {φ}_{2} \times sin ( {α}_{d} ( t ) - {φ}_{1} ) \\ {V}_{L 4} ( t ) = - 2 \sqrt{10} K ( t ) cos {φ}_{1} \times sin ( {α}_{d} ( t ) - {φ}_{2} )\end{matrix} ,$$
where φ₁ is a first initial phase, and φ₂ is a second initial phase.

5. The wide-range displacement monitoring method in accordance with claim 4, wherein the first initial phase is derived as
φ₁=(θ₁+θ₂)/2,
and the second initial phase is derived as
φ₂=(θ₁−θ₂)/2,
where ϑ₁=tan⁻¹(−3) and ϑ₂=tan⁻¹(−⅓).

6. The wide-range displacement monitoring method in accordance with claim 4, wherein amplitude calibration of the first, second, third and fourth combined signals are expressed as
$$\{ \begin{matrix}A = \sqrt{\vert \frac{1}{T} {\sum }_{t = 1}^{T} ( {V}_{L 1}^{2} ( t ) + {V}_{L 3}^{2} ( t ) ) \vert} = \vert 2 \sqrt{10} K ( t ) cos {φ}_{2} \vert \times \sqrt{\vert 1 - cos 2 {φ}_{1} \times M \vert} \\ B = \sqrt{\vert \frac{1}{T} {\sum }_{t = 1}^{T} ( {V}_{L 2}^{2} ( t ) + {V}_{L 4}^{2} ( t ) ) \vert} = \vert 2 \sqrt{10} K ( t ) cos {φ}_{1} \vert \times \sqrt{\vert 1 - cos 2 {φ}_{2} \times M \vert}\end{matrix} ,$$
where A is a first amplitude calibration factor, B is a second amplitude calibration factor, M is a Doppler phase factor and represented as
$$M = \frac{1}{T} {\sum }_{t = 1}^{T} cos 2 {α}_{d} ( t ) . ,$$
the computing device is configured to divide the first and third combined signals by the first amplitude calibration factor to obtain the first and third amplitude-calibrated signals and divide the second and fourth combined signals by the second amplitude calibration factor to obtain the second and fourth amplitude-calibrated signals, and the first, second, third and fourth amplitude-calibrated signals are derived as
$$\{ \begin{matrix}{V}_{cal 1} ( t ) = \frac{{V}_{L 1} ( t )}{A} = \frac{sin ( {α}_{d} ( t ) - {φ}_{1} )}{\sqrt{\vert 1 - M cos 2 {φ}_{1} \vert}} \\ {V}_{cal 2} ( t ) = \frac{{V}_{L 2} ( t )}{A} = \frac{sin ( {α}_{d} ( t ) - {φ}_{2} )}{\sqrt{\vert 1 - M cos 2 {φ}_{2} \vert}} \\ {V}_{cal 3} ( t ) = \frac{{V}_{L 3} ( t )}{A} = \frac{sin ( {α}_{d} ( t ) - {φ}_{1} )}{\sqrt{\vert 1 - M cos 2 {φ}_{1} \vert}} \\ {V}_{cal 4} ( t ) = \frac{{V}_{L 4} ( t )}{A} = \frac{sin ( {α}_{d} ( t ) - {φ}_{2} )}{\sqrt{\vert 1 - M cos 2 {φ}_{2} \vert}}\end{matrix} ,$$
where V_{cal1}(t) is the first amplitude-calibrated signal, V_{cal2}(t) is the second amplitude-calibrated signal, V_{cal3}(t) is the third amplitude-calibrated signal, and V_{cal4}(t) is the fourth amplitude-calibrated signal.

7. The wide-range displacement monitoring method in accordance with claim 1, wherein amplitude calibration of the first, second, third and fourth combined signals includes a first step and a second step, the computing device is configured to evaluate a first amplitude calibration factor utilizing the first and third combined signals and evaluate a second amplitude calibration factor utilizing the second and fourth combined signals in the first step, and the computing device is configured to divide the first and third combined signals by the first amplitude calibration factor to obtain the first and third amplitude-calibrated signals and divide the second and fourth combined signals by the second amplitude calibration factor to obtain the second and fourth amplitude-calibrated signals in the second step.

8. The wide-range displacement monitoring method in accordance with claim 6, wherein nonlinear combination of the first, second, third and fourth amplitude-calibrated signals are expressed as
$$I ( t ) = {V}_{cal 1}^{2} ( t ) - {V}_{cal 2}^{2} ( t ) + {V}_{cal 3}^{2} ( t ) - {V}_{cal 4}^{2} ( t ) = \frac{1}{\vert 1 - M cos 2 {φ}_{1} \vert} - \frac{1}{\vert 1 - M cos 2 {φ}_{2} \vert} + ( - \frac{cos 2 {φ}_{1}}{\vert 1 - M cos 2 {φ}_{1} \vert} + \frac{cos 2 {φ}_{2}}{\vert 1 - M cos 2 {φ}_{1} \vert} ) cos 2 {α}_{d} ( t )$$
$$and$$
$$Q ( t ) = - {V}_{cal 1}^{2} ( t ) - {V}_{cal 2}^{2} ( t ) + {V}_{cal 3}^{2} ( t ) + {V}_{cal 4}^{2} ( t ) = - ( \frac{sin 2 {φ}_{1}}{\vert 1 - M cos 2 {φ}_{1} \vert} + \frac{sin 2 {φ}_{2}}{\vert 1 - M cos 2 {φ}_{2} \vert} ) sin 2 {α}_{d} ( t ) ,$$
where I(t) is the in-phase channel signal, and Q(t) is the quadrature channel signal.

9. The wide-range displacement monitoring method in accordance with claim 8, wherein before demodulating the in-phase channel signal and the quadrature channel signal, the computing device is configured to apply a one-unknown-parameter optimization on the in-phase channel signal and the quadrature channel signal via Pythagorean trigonometric identity to find the Doppler phase factor, the one-unknown-parameter optimization is given as
I*²(t)+Q*²(t)=1,
where I*(t) is an optimized in-phase channel signal, and Q*(t) is an optimized quadrature channel signal.

10. The wide-range displacement monitoring method in accordance with claim 9, wherein the computing device is configured to apply an arctangent demodulation on the optimized in-phase channel signal and the optimized quadrature channel signal to obtain the Doppler phase, and the arctangent demodulation is expressed as
$${α}_{d} ( t ) = \frac{1}{2} {tan}^{- 1} ( \frac{Q * ( t )}{I * ( t )} ) = \frac{1}{2} {tan}^{- 1} ( \frac{sin 2 {α}_{d} ( t )}{cos 2 {α}_{d}} ) .$$
